(19) United States
(12) Patent Application Publication
(10) Pub. No.: US 2001/0049702 A1
(43) Pub. Date: Dec. 6, 2001

(54) Service side filtering XML messages in a distributed network

(75) Inventor: Farrukh S. Najmi, Reading, MA (US)

Correspondence Address: BEYER WEAVER & THOMAS LLP, P.O. BOX 778, BERKELEY, CA, 94704-0778, US

(73) Assignee: Sun Microsystems, Inc.

(21) Appl. No.: 09/863,116

(22) Filed: May 22, 2001

Related U.S. Application Data
(60) Provisional application No. 60/209,643, filed on Jun. 5, 2000.

(51) Int. Cl. G06F 15/00

(52) U.S. Cl. 707/513; 707/515

(57) ABSTRACT

A JMS provider first applies any specified JMS selector to determine if the message is to be sent to the topic subscriber. If the answer is yes, the JMS provider under this invention checks if the message is an XML message. If it is an XML message, and it conform to the specified XML schema it is transformed using the specified filter and an XSLT engine. The resulting modified XML document is sent to the topic subscriber. In the case that it is an XML message but one that conforms to a different schema than the one specified with the filter, then the XML message is sent without any transformation to the topic subscriber.

### CROSS REFERENCE TO RELATED APPLICATION

This application takes priority under 35. U.S.C. 119(e) from U.S. Provisional Patent Application filed on Jun. 5, 2000, and given Ser. No. 60/209,643, entitled “SERVICE SIDE FILTERING OF XML MESSAGES IN A DISTRIBUTED NETWORK” by Najmi which is incorporated by reference in its entirety for all purposes.

### BACKGROUND OF THE INVENTION

1. Field of Invention

The invention relates generally to computer systems. More particularly, methods and apparatus for transmitting selected portions of an XML message in a distributed network thereby reducing network bandwidth and latency.

2. Description of Relevant Art

Message Oriented Middleware (MOM) or Messaging systems such as Java Message Service (JMS) provide for reliable loosely coupled communication between software applications and components. XML documents provide a loosely coupled format for exchanging business content between software applications, components and e-Businesses. Use of MOM systems to exchange XML messages provides loose coupling in both the data content as well as the means to exchange that data content. In this scenario, a publisher will publish an XML message to a Queue or Topic in the MOM system. A subscriber may subscribe to the Queue or Topic and receive the XML message. Often in such exchanges the subscriber is only interested in a small subset of the original XML message. Another possible use case is where the subscriber is interested in a specific transformation of the original XML message. Currently, MOM systems such as JMS based systems only provide for the subscriber to specify a selector query that can be applied at the MOM service to determine whether the Message qualifies for being sent to the subscriber. With XML messages it is highly advantageous to be able to specify an additional XSLT (XSL transformations) filter that can be applied by the MOM service to transform the message on behalf of the subscriber prior to sending it to the subscriber. It is well known in the art that XSLT is a standard way to describe how to transform (change) the structure of an XML (Extensible Markup Language) document into an XML document with a different structure. XSL is a language for formatting an XML document (for example, showing how the data described in the XML document should be presented in a Web page).

By providing an server side XML transformation, network bandwidth and latency can be substantially improved since only those portions of the XML statements required by the subscriber are sent “over the wire”. One such a situation can be illustrated by the following contrived example. Lets say a publisher publishes the entire Macbeth play by Shakespeare and that a subscriber is only interested in the “ACT” names in the play and nothing else. By applying the XSLT filter on the service side prior to sending the message we are able to dramatically reduce the size of the message and save on network bandwidth and latency by filtering the ACT names and nothing else.

Therefore, in view of the foregoing, it would be advantageous and therefore desirable to have a method and apparatus for providing selective server side filtering of XML messages in a distributed network of computers.

### SUMMARY OF THE INVENTION

A method, apparatus, and system for providing selective server side filtering of XML messages in a distributed network of computers is described. This method, apparatus, and system allows setting an XSLT filter for all XML messages that conform to a specified XML schema.

As a method, the JMS provider first applies any specified JMS selector to determine if the message is to be sent to the topic subscriber. If the answer is yes, the JMS provider under this invention checks if the message is an XML message. If it is an XML message, and it conform to the specified XML schema it is transformed using the specified filter and an XSLT engine. The resulting modified XML document is sent to the topic subscriber. In the case that it is an XML message but one that conforms to a different schema than the one specified with the filter, then the XML message is sent without any transformation to the topic subscriber.

In another embodiment, an apparatus arranges to provide service side filtering of a message in a distributed network is disclosed.

In yet another embodiment, computer program product for providing service side filtering of a message in a distributed network is disclosed.

### BRIEF DESCRIPTION OF THE DRAWINGS

The invention, together with further advantages thereof, may best be understood by reference to the following description taken in conjunction with the accompanying drawings in which:

FIG. 1 shows an enterprise computer system in accordance with an embodiment of the invention.

FIG. 2 shows a flowchart detailing a process for filtering an XML message in a distributed network in accordance with an embodiment of the invention.

FIG. 3 illustrates a computer system that can be employed to implement the present invention.

### DETAILED DESCRIPTION OF THE EMBODIMENTS

Reference will now be made in detail to a preferred embodiment of the invention. An example of the preferred embodiment is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as may be included within the spirit and scope of the invention as defined by the appended claims.

In the described embodiment, a JMS provider first applies any specified JMS selector to determine if the message is to be sent to the topic subscriber. If the answer is yes, the JMS provider under this invention checks if the message is an XML message. If it is an XML message, and it conform to the specified XML schema it is transformed using the specified filter and an XSLT engine. The resulting modified XML document is sent to the topic subscriber. In the case that it is an XML message but one that conforms to a different schema than the one specified with the filter, then the XML message is sent without any transformation to the topic subscriber.

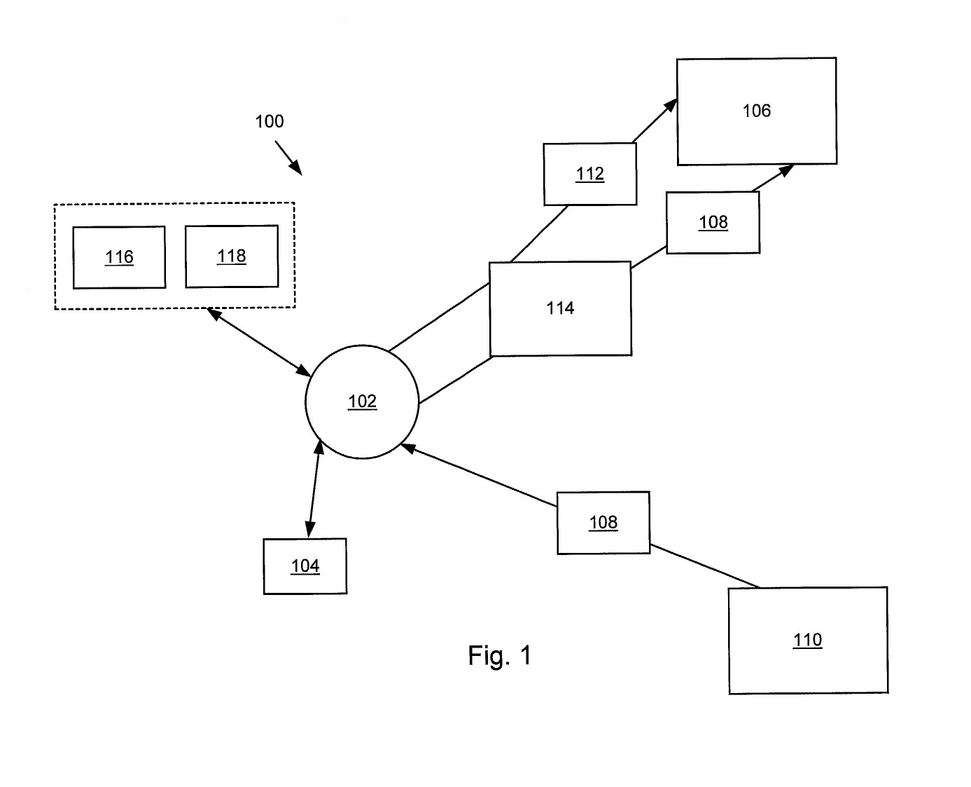

FIG. 1 shows a message server 100 in accordance with an embodiment of the invention. The message server 100 includes a topic 102 coupled to a selector 104 arranged to determine whether or not a particular subscriber 106 is to receive a message 108 from a message publisher 110. In the described embodiment, the message server 100 is a Java Message Server (JMS) 100, the topic 102 is a topic subscriber 104, the message 108 is an XML message 108 and the publisher 110 is an XML publisher 110. If the selector 104 determines that the XML message 108 is to be sent to the subscriber 106, a determination is made if the XML message 108 is to be transformed into an XML message 112 based upon a schema associated with the subscriber 106 . If the selector determines that the particular message is not to be transformed, then the XML message 108 in its native format is sent to the subscriber 106 by way of an XML publisher 114. If on the other hand, the XML message 108 is to be transformed, then an XSLT engine 116 in combination with an XSLT filter 118 corresponding to the desired schema, translate the XML message 108 into the XML message 112 in accordance with the schema associated with the subscriber 106. In this way, substantial network bandwidth and latency is preserved since only those selected portions of the XML message 108 is sent “over the wire” to the subscriber 106.

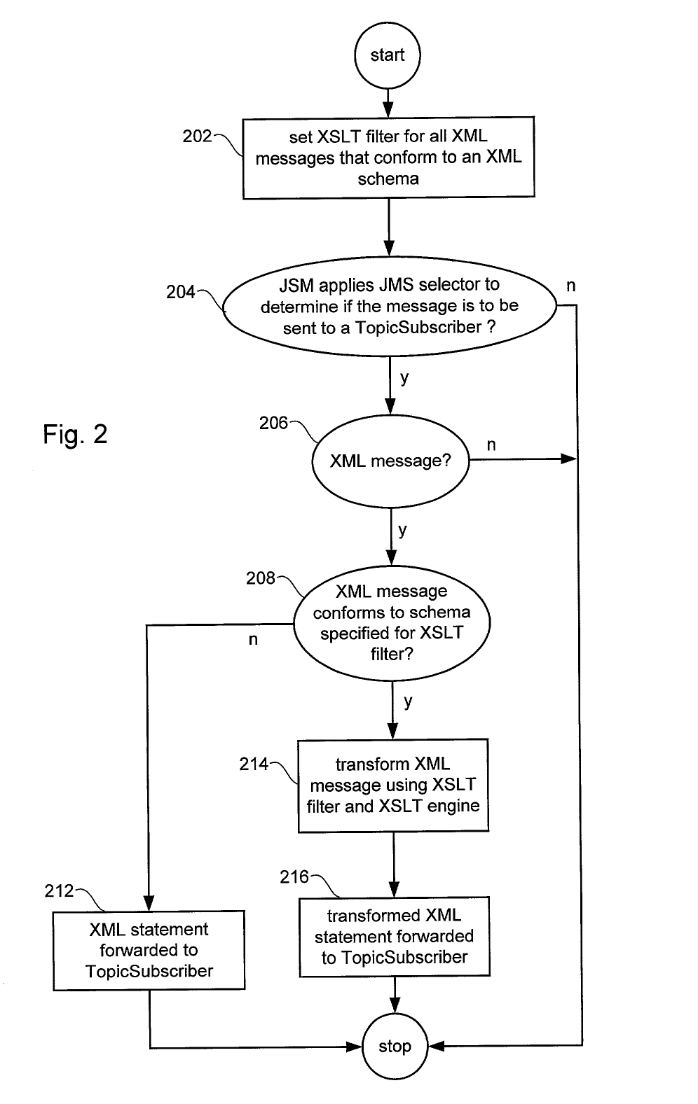

FIG. 2 illustrates a flowchart detailing a process 200 for transforming an XML message in accordance with an embodiment of the invention. The process 200 begins at 202 by setting the XSLT filter for all XML messages that conform to an XML schema. At 204, the JMS selector determines if a message is to be sent to a topic subscriber. If the message is to be sent to the topic subscriber, then a determination is made at 206 if the message is an XML message, otherwise, processing stops. If the message is an XML message, then a determination is made to 208 whether or not the message conforms to the schema specified by the XSLT filter. If the message does not conform to the schema, then the XML statement in native format is sent to the topic subscriber at 212. If, however, the message does conform to the schema, then the XML message is transformed using the XSLT filter and an associated XSLT engine at 214. At 216, the transformed message is then forwarded to the topic subscriber.

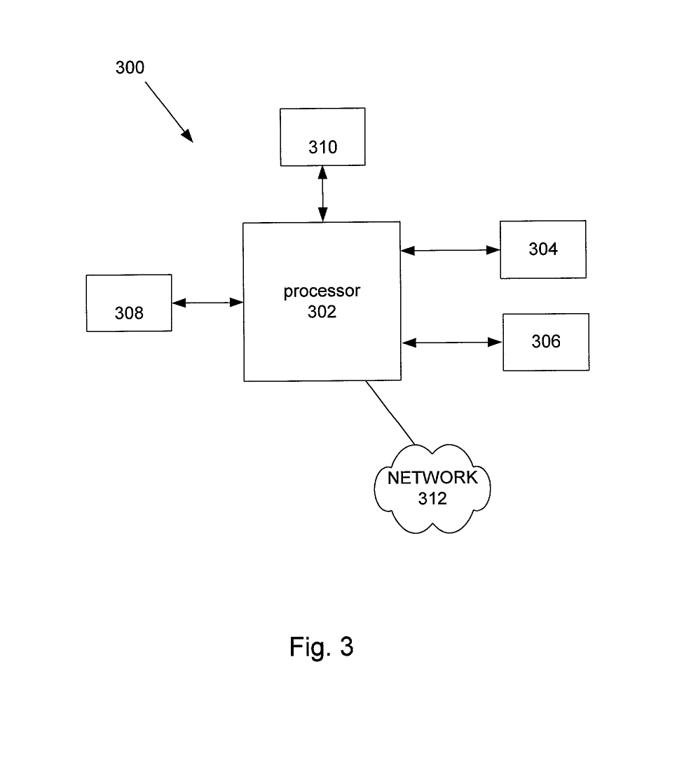

FIG. 3 illustrates a computer system 300 that can be employed to implement the present invention. The computer system 300 or, more specifically, CPUs 302, may be arranged to support a virtual machine, as will be appreciated by those skilled in the art. As is well known in the art, ROM acts to transfer data and instructions uni-directionally to the CPUs 302, while RAM is used typically to transfer data and instructions in a bi-directional manner. CPUs 302 may generally include any number of processors. Both primary storage devices 304, 306 may include any suitable computer-readable media. A secondary storage medium 308, which is typically a mass memory device, is also coupled bi-directionally to CPUs 302 and provides additional data storage capacity. The mass memory device 308 is a computer-readable medium that may be used to store programs including computer code, data, and the like. Typically, mass memory device 308 is a storage medium such as a hard disk or a tape which generally slower than primary storage devices 304, 306. Mass memory storage device 308 may take the form of a magnetic or paper tape reader or some other well-known device. It will be appreciated that the information retained within the mass memory device 308, may, in appropriate cases, be incorporated in standard fashion as part of RAM 306 as virtual memory. A specific primary storage device 304 such as a CD-ROM may also pass data uni-directionally to the CPUs 302.

CPUs 302 are also coupled to one or more input/output devices 310 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPUs 302 optionally may be coupled to a computer or telecommunications network, e.g., an Internet network, or an intranet network, using a network connection as shown generally at 312. With such a network connection, it is contemplated that the CPUs 302 might receive information from the network, or might output information to the network in the course of performing the above-described method steps. Such information, which is often represented as a sequence of instructions to be executed using CPUs 302, may be received from and outputted to the network, for example, in the form of a computer data signal embodied in a carrier wave. The above-described devices and materials will be familiar to those of skill in the computer hardware and software arts.

It should be noted that the present invention employs various computer-implemented operations involving data stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms, such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should remembered however, that all of these and similar terms are to be associated with the appropriate physical quantities and are merely convenient labels applied to these quantities.

The present invention also relates to a device, system or apparatus for performing the aforementioned operations. The system may be specially constructed for the required purposes, or it may be a general-purpose computer selectively activated or configured by a computer program stored in the computer. The processes presented above are not inherently related to any particular computer or other computing apparatus. In particular, various general-purpose computers may be used with programs written in accordance with the teachings herein, or, alternatively, it may be more convenient to construct a more specialized computer system to perform the required operations.

Although only a few embodiments of the present invention have been described, it should be understood that the present invention may be embodied in many other specific forms without departing from the spirit or the scope of the present invention.

It should also be appreciated that the present invention may generally be implemented on any suitable object-oriented computer system. Therefore, the present examples are to be considered as illustrative and not restrictive, and the invention is not to be limited to the details given herein, but may be modified within the scope of the appended claims along with their full scope of equivalents.

What is claimed is:

1. A method of service side filtering of a message in a distributed network, comprising:
(a) determining if the message is to be sent to a topic subscriber;
(b) determining if the message is an extensible markup language (XML) message that conforms to an XML schema specified by a selected XSLT filter;
(c) transforming the XML message to form a modified XML message; and
(d) sending the modified XML message to the topic subscriber.

2. A method as recited in claim 1, wherein the determining (a) is performed by a JMS provider.

3. A method as provided in claim 1, wherein the transforming is based up the specified XSLT filter and an associated XSLT engine.

4. A method as recited in claim 1, wherein if determining (b) determines that the XML message conforms to a different schema than specified with the XSLT filter, then
sending the XML message without any transformation to the topic subscriber.

5. An apparatus arrange to provide service side filtering of a message in a distributed network, comprising:
a first means for determining if the message is to be sent to a topic subscriber;
a second means coupled to the first means for determining if the message is an extensible markup language (XML) message that conforms to an XML schema specified by a selected XSLT filter;
a third means coupled to the second means for transforming the XML message to form a modified XML message; and
a fourth means coupled to the third means for sending the modified XML message to the topic subscriber.

6. An apparatus as recited in claim 5, wherein the first means for includes a JMS provider.

7. An apparatus as provided in claim 5, wherein the second means is based up the specified XSLT filter and an associated XSLT engine.

8. An apparatus as recited in claim 5, wherein if second means determines that the XML message conforms to a different schema than specified with the XSLT filter, then the apparatus further includes,
a fifth means for sending the XML message without any transformation to the topic subscriber.

9. Computer program product for providing service side filtering of a message in a distributed network, comprising:
computer code for determining if the message is to be sent to a topic subscriber; computer code for determining if the message is an extensible markup language (XML) message that conforms to an XML schema specified by a selected XSLT filter;
computer code for transforming the XML message to form a modified XML message;
computer code for sending the modified XML message to the topic subscriber; and
a computer readable medium for storing the computer program product.

10. Computer program product as recited in claim 9, wherein the is computer code for determining is executed by a JMS provider.

11. Computer program product as provided in claim 9, wherein the computer code for transforming is based up the specified XSLT filter and an associated XSLT engine.

12. Computer program product as recited in claim 9, wherein if determining (b) determines that the XML message conforms to a different schema than specified with the XSLT filter, then the computer program product further includes,
computer code for sending the XML message without any transformation to the topic subscriber.
